(19) United States
(12) Patent Application Publication
(10) Pub. No.: US 2013/0291098 A1
(43) Pub. Date: Oct. 31, 2013

(54) DETERMINING TRUST BETWEEN PARTIES FOR CONDUCTING BUSINESS TRANSACTIONS

(71) Applicants: Seong Taek Chung, San Francisco, CA (US); Michael Chun, SR., Standford, CA (US)

(72) Inventors: Seong Taek Chung, San Francisco, CA (US); Michael Chun, SR., Standford, CA (US)

(21) Appl. No.: 13/798,797

(22) Filed: Mar. 13, 2013

Related U.S. Application Data
(60) Provisional application No. 61/640,382, filed on Apr. 30, 2012.
(60) Provisional application No. 61/672,718, filed on Jul. 17, 2012.
(60) Provisional application No. 61/711,659, filed on Oct. 9, 2012.

(51) Int. Cl. G06F 21/50

(52) U.S. Cl. CPC G06F 21/50
USPC 726/21

(57) ABSTRACT

Trust is calculated between persons for purposes of a business transaction. A measure of relative trust is determined for a target user with respect to a source user based on common entities that are related to both the users, for example, common relations, common background, or common preferences. A measure of absolute trust is determined for the target user using factors including financial information, work history, and so on. The absolute trust for the target user is improved using trusts of other users connected to the target user. The absolute trust and relative trusts are combined to obtain an overall measure of trust for the target user. The measure of trust for the user may be used for a business transaction, for example, lead generation, angel investment, equity crowd funding, and sharing of a product or service with another person.

### CROSS REFERENCES TO RELATED APPLICATIONS

This application claims the benefit of U.S. Provisional Patent Application No. 61/640,382 filed on Apr. 30, 2012, U.S. Provisional Patent Application No. 61/672,718, filed on Jul. 17, 2012, and U.S. Provisional Patent Application No. 61/711,659 filed on Oct. 9, 2012, each of which is incorporated by reference in its entirety.

### BACKGROUND

This invention relates to calculating trust between parties based on social information and domain specific business information.

Business transactions typically involve interactions between two or more parties. For example, a party may provide a product or service to another party in return for payment. A party may share a product or service with other people that are strangers to that party. For example, a person may share that person's room or house with a stranger for payment. An investor may invest money in a venture of an entrepreneur. As an example of investing, an early stage small business may raise funding from a large number of parties using equity crowd funding. An early stage investor may raise money from one or more angel investors. Shareholders of a private company may sell their shares to accredited investors in a secondary share-market.

Parties attempt to evaluate whether they can trust another party for purposes of a business transaction. A party may consider multiple parties as potential candidates for purposes of a business transaction. The party may prefer to conduct the business with someone that the party considers most trustworthy for the business transaction. If a party does not have a good mechanism to evaluate other parties for conducting business, the party may reject suitable candidates with whom the party could have conducted successful business. For example, an angel investor may not invest in an entrepreneur that was worth investing. Alternatively, the party may start the business transaction with an unsuitable party and realize later that the party was unsuitable. For example, the angel investor may invest in a party and later realize that the investment was bad. Conventional techniques do not provide a suitable mechanism for a party to determine whether another party is suitable for purposes of conducting a business transaction.

### SUMMARY

Embodiments of the invention relate to estimating trust between two users using relative trust between the two users and absolute trust of one of the users. A trust calculation system receives a request to determine measure of trust for a target user with respect to a source user for purposes of conducting a business transaction. The trust calculation system determines a measure of relative trust between the source user and the target user. The trust calculation system also determines an absolute trust for the target user that is independent of any particular source user. The trust calculation system combines the relative trust and the absolute trust to determine the measure of trust for the target user.

In one embodiment, the trust calculation system may determines the relative trust between the users based on common entities between the two users. The trust calculation system may obtain information describing the users from one or more social networking systems. The trust calculation system may infer additional information based on the information obtained from the social networking systems. The trust calculation system may infer relations between users that are not present in any of the social networking system individually.

In one embodiment, the trust calculation system determines the absolute trust for the target user based on various factors including the financial information of the target user. The trust calculation system may improve the accuracy of the absolute trust for the target user based on the trust values of other users connected to the target user. The trust calculation system may iteratively improve the absolute trust of each user based on an aggregate value based on the trust of the connections of the user.

In one embodiment, the trust calculation system imports information describing characteristic of users from social networking systems. The trust calculation system determines a measure of attitude of a user with respect to each social networking system from which information is imported. The attitude of the user describes how carefully the user uses the social networking system. The trust calculation system may use the attitude of the user to weigh the information obtained from each social networking system.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

FIG. 1 is a diagram of a system environment for determining trust score for users, in accordance with an embodiment.

FIG. 2 is a diagram of the system architecture of a trust calculation system for determining trust scores of users, in accordance with an embodiment.

FIG. 3 is a flowchart of the overall process for importing and aggregating information from multiple external sources, in accordance with one embodiment.

FIG. 4 is a conceptual diagram illustrating how common relation information is inferred by combining information from multiple social networking systems, in accordance with an embodiment.

FIG. 5 is a flowchart of a process for determining a trust score for a target user with respect to a source user, in accordance with one embodiment of the invention.

FIG. 6 is a flowchart of a process for calculating absolute trust scores for users, in accordance with one embodiment of the invention.

FIG. 7 is a flowchart of a process for adjusting the weights used for calculating trust scores, in accordance with one embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

Embodiments relate to determining a measure of trust of a target person with respect to a source person. The measure of trust for the target person may be used by the source person for various reasons including, among others, whether the source person should perform a business transaction with the target person. For example, an angel investor may use the measure of trust to decide whether the angel investor should invest money in a venture started by another person. Or a person interested in sharing a house or room with a stranger may use the measure of trust to decide whether the person should trust the stranger for purposes of sharing the house or room. The measure of trust for a set of candidates may be determined with respect to a source person to rank the candidates based on their suitability for performing a business transaction. The description herein also refers to a person as a user.

Trust described herein refers to the level of confidence that a source user can place upon a target user. Trust may refer to a level of confidence that a source user can place upon a target user to perform a given task. In other words, trust refers to reliability of a person for purposes of a given task, i.e., whether the person can be relied upon to complete a task successfully. For example, if a source user is interested in executing a business transaction with a target user, the source user expects the business transaction to succeed. The source user is likely to enter into the business transaction with the target user if the source user trusts that the target user is likely to successfully execute the business transaction and provide the expected outcome. On the other hand, if the target user is likely to cheat in the transaction or unlikely to provide the expected outcome of the business transaction, the source user should have less trust in the target user or should not trust the target user.

The trust scores determined herein may be used for any type of task and are not limited to business purposes. For example, the trust scores may be used for tasks performed gratis without charging any fees. The trust scores may be used for tasks performed for charitable purposes. The trust score may be used even if there is no resulting task performed by any party, for example, simply to inspect the relationship between two parties. The trust score may be used for a task that is performed mutually by two parties in a cooperative fashion.

Embodiments determine two types of trust, one is relative trust and the other is absolute trust. The relative trust is a measure of trust between two individuals. In other words, the relative trust for a target user is determined with respect to a source user. Relative trust is significant because even if a person is not very reliable in general, the person may be reliable with respect to a particular person. For example, if there are common friends between the source user and the target user, the target user is likely to act reliably in a business transaction with the source user.

The absolute trust of a person is a measure of trust that is inherent to that specific individual. The absolute trust value is independent of any source user. For example, the credit rating of a user may be an indication of how reliable a person may be in a financial transaction. Similarly, if a person has cheated in several transactions before, the measure of absolute trust of the person would be considered low since the person is not likely to be reliable in business transactions. Similarly, if a person has no employment experience in a particular field, the person should be trusted less for purposes of starting a business venture in the field.

Embodiments determine an overall trust score for a target user by combining absolute trust and relative trust of the target user with respect to a source user. Information is imported from various systems for use in determining the trust scores. For example, social information may be imported from social networking systems and business or other type of information may be imported from domain specific information systems. The relative trust for the target user is determined with respect to the source user based in commonality between the two users, for example, common relations. Absolute trust for the target user is determined based on various factors indicative of reliability of the user in a business transaction, for example, credit rating, past transactions of the user, financial status of the user, and so on.

An overall trust score for the target user with respect to the source user may be determined as a weighted average of the absolute trust of the target user and relative trust of the target user with respect to a source user. The trust score are updated as new information is obtained about the user. For example, if information indicating an incident of cheating by the user is obtained, the trust score of the user may be reduced. In contrast, if the credit rating of the user increases over time, the updated credit rating may be used to reevaluate the absolute trust of the user.

### System Environment for Determining Trust Scores

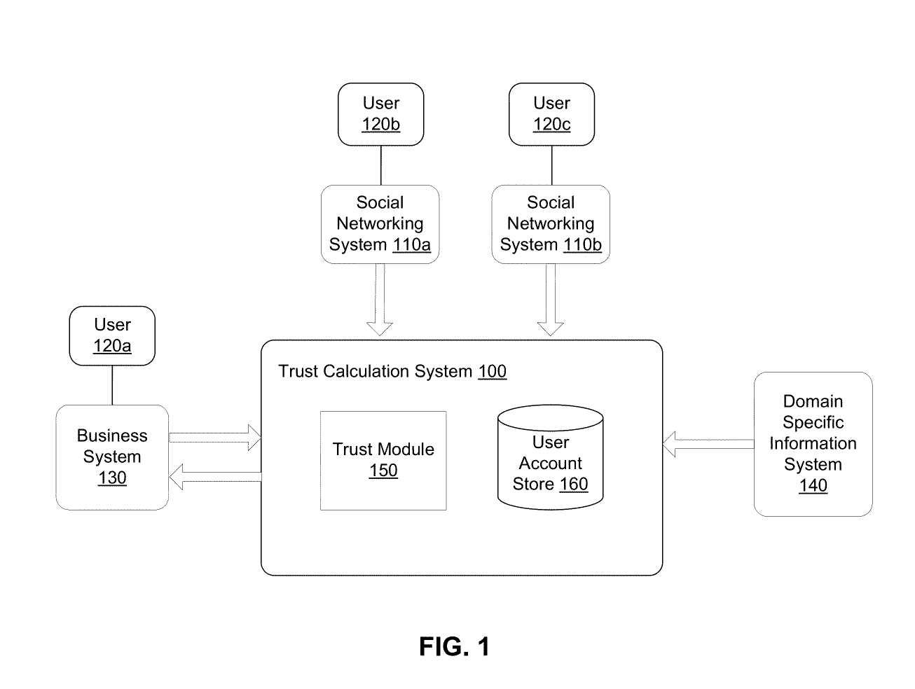

FIG. 1 is a diagram of a system environment for determining trust score for users, in accordance with an embodiment of the invention. The system environment for determining trust score for users comprises a trust calculation system 100, one or more social networking systems 110, one or more domain specific information systems 140, and a business system 130. Some embodiments of the systems 100, 110, 130, and 140 have different and/or other modules than the ones described herein, and the functions can be distributed among the modules in a different manner than described herein.

FIG. 1 and the other figures use like reference numerals to identify like elements. A letter after a reference numeral, such as “110A,” indicates that the text refers specifically to the element having that particular reference numeral. A reference numeral in the text without a following letter, such as “110,” refers to any or all of the elements in the figures bearing that reference numeral (e.g., “110” in the text refers to reference numerals “110A” and/or “110B” in the figures).

The business system 130 may be any system that conducts or facilitates certain type of business transactions. For example, the business system 130 may allow users to share their products or services with other users or facilitate investments by angel investors or facilitates crowd source funding. The business system 130 interacts with the trust calculation system 100 to determine measures of trusts that may be used for purposes of determining whether two parties enter a business transaction.

In some embodiments, the business system 130 may be replaced by any system configured to perform or help with performing a task. The tasks associated with the business are not limited to business tasks. For example, a system may help with tasks performed gratis without charging any fees. The system may be used for tasks performed for charitable purposes. Alternatively a system may perform tasks for free and earn a revenue using some other mechanism, for example, by online advertising.

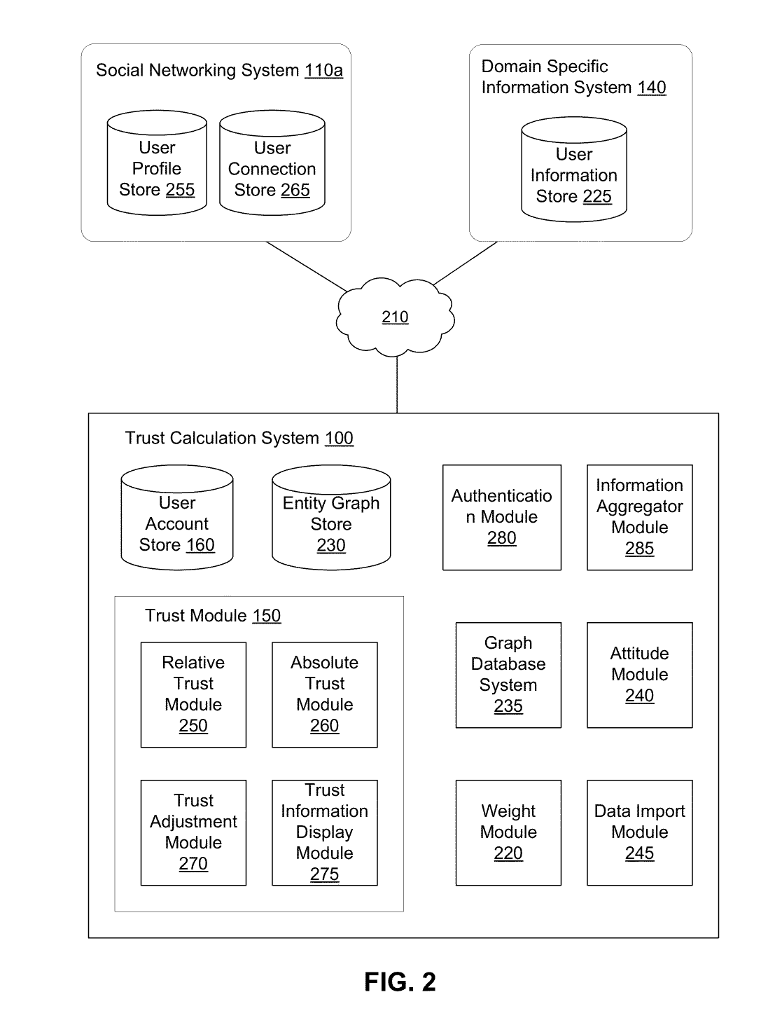

The trust calculation system 100 comprises a trust module 150 and a user account store 160. The trust module 150 determines trust between two parties, for example, a source user and a target user. The trust calculation system 100 comprises modules other than those shown in FIG. 1, for example, modules illustrated in FIG. 2 that are further described herein.

The business system 130 may send a request to the trust calculation system 100 to determine a measure of trust between a source user and a target user. For example, a business allowing a user to share a product or service with another user may send a request on behalf of a first user to rank a set of candidate users in terms of how much each user can be trusted for purposes of sharing certain product or service. The trust calculation system 100 may determine a trust score for each of the candidate users and provide the result to the business system 130. Alternatively, the trust calculation system 100 may rank the candidate users based on a measure of trust of each candidate user such that the highest ranked user is the most trustworthy user for conducting a business transaction.

The trust calculation system 100 interacts with the social networking systems 110 and the domain specific information systems 140 to determine a trust score for each candidate user. For example, the trust calculation system 100 imports social information describing users from one or more social networking systems 110. The information imported from the social networking systems 110 is used to identify commonality between a source user and a target user, for example, whether there are common relations between the two users, common background, or common preferences. The presence of commonality between two users is considered as a factor indicating a higher likelihood of trust between the two users. Accordingly, if there are common relations between two users, the two users are more likely to trust each other.

The trust calculation system 100 also interacts with one or more domain specific information systems 140 to retrieve information relevant to determining trust for a party. For example, the domain specific information system may provide information including credit rating of a user, whether the user is a home owner, types of transactions that the user was involved in previously, work history of the user and so on. If a user has good credit rating, has been working in or been involved in transactions with businesses similar to those for which trust needs to be evaluated, the user may be considered more trust worthy compared to a user with bad credit rating who has never interacted with similar businesses.

The users 120 interact with one or more systems described above, for example, the social networking systems 110 or the business systems 130 using a client device. The client device used by a user 120 may be a personal computer (PC), a desktop computer, a laptop computer, a notebook, a tablet PC executing an operating system, for example, a Microsoft Windows-compatible operating system (OS), Apple OS X, and/or a Linux distribution. In an embodiment, the client device 105 can be any device having computer functionality, such as a personal digital assistant (PDA), mobile telephone, smartphone, etc. Furthermore, each of the systems 100, 110, 130, and 140 executes on a computer system that includes at least a processor, memory, secondary storage, and one or more peripheral devices, for example, a keyboard, display monitor, or pointing devices.

### System Architecture for Determining Trust Score

FIG. 2 is a diagram of the system architecture of a trust calculation system for determining trust scores of users, in accordance with an embodiment of the invention. The trust calculation system interacts with one or more social networking systems 110 and domain specific information systems 140 via a network 210. The trust calculation system 100 includes a trust module 150, a user account store 225, an entity graph store 230, an authentication module 280, a graph database system 235, an attitude module 240, a weight module 220, and a data import module 245. In other embodiments, the trust calculation system 100 may include additional, fewer, or different modules for various applications. Conventional components such as network interfaces, security mechanisms, load balancers, failover servers, management and network operations consoles, and the like are not shown so as to not obscure the details of the system.

The authentication module 280 allows a user to provide credentials to login in to the trust calculation system 100. The authentication module also allows the trust calculation system 100 to retrieve information from external systems that may require user authentication for providing information describing the user. Examples of external systems include social networking systems 110 and domain specific information systems 140. The trust calculation system 100 may present a user interface to a user to allow the user to provide credentials for external systems. The authentication module 280 communicates with the external systems and provides the user credentials. After the proper credentials are provided to the external system, the trust calculation system 100 communicates with the external system to retrieve user information. Examples of information retrieved from external systems, for example, social networking systems 110 includes user profile information and connections of the user.

The user account store 160 stores information about users. The user information stored in the user account store 160 includes information identifying the user, authentication information, demographic information, for example, address, gender, age, education, and the like. The information describing a user may either be provided by a user to the trust calculation system 100 or imported from an external system, for example, social networking system 110 or domain specific information systems 140. The information describing a user may be stored in the user account store 160 or it may be stored in another store and associated with the user account. The user account store 160 may associate various types of information inferred by the trust calculation system 100 with the user account, for example, relative trust score, absolute trust score, and total trust score.

The entity graph store 230 stores relationships between various entities represented in the trust calculation system 100. Each node represented in the entity graph corresponds to an entity represented in the trust calculation system 100 and each edge in the entity graph between two nodes corresponds to a relationship between the two nodes. For example, if the trust calculation system 100 determines that two users are connected in a social networking system 110, the trust calculation system 100 may create an edge between nodes representing the two users. The trust calculation system 100 may represent different types of entities as nodes, for example, images, organizations, groups, events, books, movies, languages, and so on. For example, if a user speaks a particular language, an edge may be created from a node representing the user to a node representing the language. Similarly, if a user is tagged in an image, an edge may be created between a node representing the user and a node representing the image.

The data import module 245 imports data describing users from external systems. For example, the data import module 245 may import user profile information or information describing connections of a user from a social networking system 110. The data import module 245 may also import domain specific information from domain specific information systems 140. For example, the data import module 245 may import credit rating of a user from a domain specific information system 140 that provides the credit rating information. Similarly, the data import module 245 may import demographic information describing a user from a domain specific information system 140 that stores such information.

The information aggregator module 285, aggregates information obtained from various external sources, for example, social networking systems 110 and domain specific information systems 140. Information describing the same person or entity may be obtained from two or more different external sources. The information aggregator module 285, analyzes the information to determine whether the information corresponds to the same user. If the information aggregator module 285, determines that certain information obtained from two different external sources describes the same user, the information aggregator module 285 combines the information. The information aggregator module 285 combines the information by storing the information in association with the user account stored in the user account store 160 and the entity graph store 230. The information aggregator module 285 may infer additional information by combining data from multiple external sources and derive information that may not be available in either of the external sources.

The graph database system 235 allows efficient execution of queries optimized for graph operations. For example, the graph database system 235 may be used for efficient querying of data stored in the entity graph store 230. The graph database system 235 is efficient compared to conventional database systems, for example, relational database systems for executing graph queries. A graph database system 235 can be used to efficiently determine common relations between two users. Similarly, the graph database system 235 can efficiently determine whether there is any node common between two users in the entity graph store 230, for example, whether the two users read the same book, whether the two users attended the same educational institution, or whether the two users attended the same event. Typically, the graph database system 235 stores a graph representation in memory and performs efficient in-memory graph operations. An example graph database system 235 that may be used by embodiments described herein is NEO4J database provided by NEO TECHNOLOGY, INC. A conventional database system may not be optimized for graph operations, for example, a relational database typically represents data as tables and may not be able to perform operations such as graph traversal efficiently.

The attitude module 240 determines attitudes of users with respect to a social networking system 110. The attitude of a user represents the way a user uses a social networking system, for example, whether the user uses the social networking system very carefully or the user uses the social networking system carelessly. For example, social networking system A may be used by users typically for social interactions and social networking system B may be typically used by users for professional interactions. A user may be very particular about maintaining accuracy of information in social networking system B and may not care about information stored in social networking system A. Another user may be particular about maintaining accuracy of information in social networking system A and may not care much about information stored in social networking system B.

A higher attitude score reflects that the user uses the social networking system 110 carefully and a lower attitude score represents that the user has a careless attitude towards the social networking system. In an embodiment, the attitude may be represented as a score, for example, a value between 1 and 10, where a value closer to 10 indicates that the user is careful about using the social networking system, a value closer to 1 indicates that the user is careless about using the social networking system and a value close to 5 indicates that the user may be considered neither careful nor careless about using the social networking system 110.

The trust module 150 determines the value of a trust score between two users. The trust module 150 comprises modules including the relative trust module 250, the absolute trust module 260, a trust adjustment module 270, and a trust information display module 275. The relative trust module 250 determines a relative trust score for a target user with respect to a source user. The absolute trust module 260 determines an absolute trust score for the target user, independent of any source user. The trust module 150 combines the relative trust score and the absolute trust score to determine the trust score for the target user with respect to the source user. The trust adjustment module 270 monitors additional information that may affect the trust score and adjusts the trust score based on such information. For example, if the credit score of the target user changes for subsequent to determining the trust score, the trust adjustment module 270 revises the trust score for the target user to reflect the change. The various modules of the trust module 150 are described in further details herein.

The trust information display module 275 sends common relation information and other relevant to determining trust for a user to a requestor. Displaying the information relevant to determining trust helps build trust between two users. The information sent by the trust information display module 275 may be displayed via a user interface, for example, a web portal. For example, the trust information display module 275 may send common relation information for displaying adjacent to information displaying the users. Then trust information display module 275 may send common background information for display, for example, displaying that the target user and the source user attended the same educational institution. The trust information display module 275 may send common preference information for display, for example, displaying that both the target user and the source user like the same television serial, movie, or book. Alternatively, the user interface may simply display that there are common relations, common background information, or common preferences between the target user and the source user.

In an embodiment, the trust information display module 275 determines the recipients of the information describing the trust calculation based on a type of business transaction. The trust information display module 275 may determine whether to send the information to only the source user or to both the source and the target user based on the type of the business transaction. For example, if the business transaction corresponds to an investment of the source user in a business venture of the target user, the trust information display module 275 may send the information describing the trust calculation to only the source user and withhold the information from the target user.

As another example, if the business transaction corresponds to the source user sharing property of the source user with the target user, the trust information display module 275 sends the information describing the trust calculation to both the source user and the target user. In this situation, sending the information to only one of the parties would affect the trust adversely. For example, if only the source user is aware of a common relation, the source user may trust the target user more than the target user trusts the source user. Since the target user is not aware of the source user's knowledge of the common relation, the target user may act in a less trustworthy manner compared to a situation in which both parties are aware of the presence of the common relation. In the case of equity crowd funding, the trust information display module 275 sends information to both the source user and the target user for reasons similar to those described above for the example of sharing property.

The social networking system 110 comprises a user profile store 255 and a user connection store 265. The user profile store 255 stores information about users of the social networking system 110 including name, address, location, interests, age, and the like. The connection store 265 stores information describing other users that are connected to the user. The users connected to a user are also referred to as the connections of the user. A user may create a connection with another user, for example, by sending a request to the other user to create a connection. The connection is established if the other user accepts the request. In some embodiments, the connection specifies a type of the connection that describes a type of the relationship between the two users, for example, family, friend, or colleague.

The domain specific information system 140 comprises a user information store 225. The user information store 225 stores information describing each user. For example the domain specific information system 140 may store credit rating of each user in the user information store 225. The domain specific information system 140 may store other information including whether a user is a home owner, assets of the user, work experience of the user, history of the user indicating whether the user was involved in any fraud and so on.

The trust calculation system 100 may communicate with each external system using APIs provided by the external system. The interactions between the trust calculation system 100 and the social networking system 110 as well as the interactions between the trust calculation system 100 and the domain specific information system 140 are typically performed via a network 210, for example, via the internet. In one embodiment, the network 210 uses standard communications technologies and/or protocols. In another embodiment, the entities can use custom and/or dedicated data communications technologies instead of, or in addition to, the ones described above. Depending upon the embodiment, the network 210 can also include links to other networks such as the Internet.

Aggregating Data from External Systems

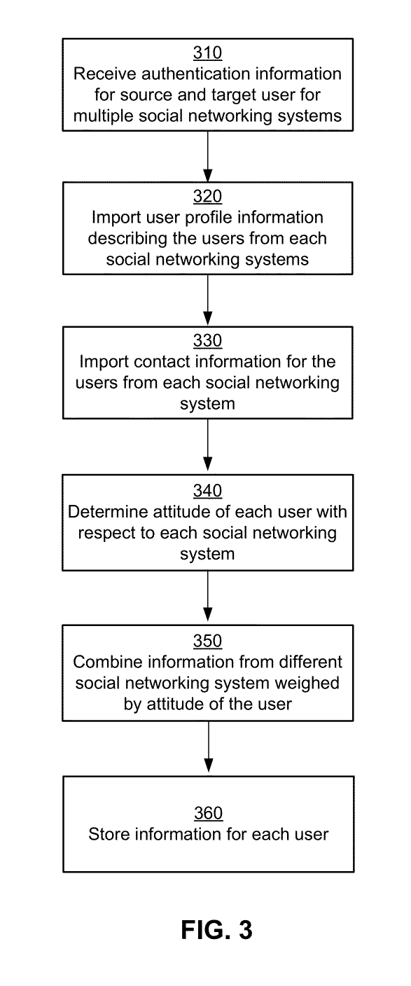

The data import module 245 imports data from external sources and the information aggregator module 285 combines the imported data. The information obtained from two different sources may be weighted based on the attitude of the user with respect to the external source as determined by the attitude module 240. FIG. 3 is a flowchart of the overall process for importing and aggregating information from multiple external sources, in accordance with one embodiment of the invention.

The authentication module 280 receives 310 authentication information for a source and target user for authenticating one or more social networking systems 110. The authentication information may include the login and password information or any other authentication mechanism required by the social networking system 110 for allowing an external system to retrieve information from the social networking system 110. The authentication module 280 may also receive authentication information for other external systems, for example, the domain specific information systems 140 if these external systems require a user's authentication to allow the trust calculation system 100 to provide access to information.

The data import module 245 imports 320 user profile information describing source and the target user from each social networking system 110. The imported user profile information may include age, address, education, income, or any other information provided by the social networking system. The data import module 245 imports 330 contact information for the source and the target user from each social networking system 110. The contact information includes information describing the connections of each user. The information describing each connection may be obtained to the extent allowed by the privacy settings of each connection.

The attitude module 240 determines 340 the attitude of the source and target users with respect to each social networking system 110 from which the information is imported for the user. The information aggregator module 285 combines 350 information from different social networking system weighed by attitude of the user. The information aggregator module 285 stores 360 the information that is imported as well as any information inferred from combined information in various data stores of the trust calculation system 100 including the user account store 160 and the entity graph store 230.

The information aggregator module 285 combines information obtained from different social networking systems 110 to determine common relations between two users, for example, a source and a target user. A common relation is a person that is connected whether directly or indirectly to both the source user and the target user. The common relation information may include the connection distance between the source user and the target user in each social networking system 110 or in the entity graph representation stored in the entity graph store 230 obtained by combining information from multiple social networking systems 110. The common relation information determined by the information aggregator module 285 may include the common connections between the two users. The common connections may be connected to the source user and the target user directly or indirectly via other users. The information aggregator module 285 may invoke the graph database system 235 to perform matching of connections of the source and the target users to identify common relations.

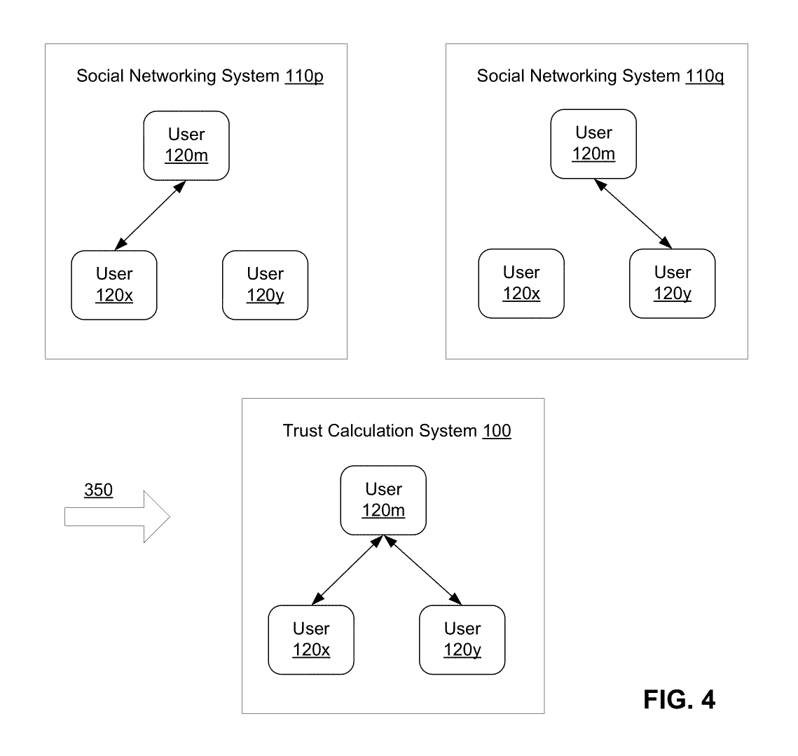

FIG. 4 illustrates how common relation information is inferred by combining multiple social networking systems 110, in accordance with an embodiment of the invention. As shown in FIG. 4, the information aggregator module 285 combines 350 connections obtained from two different social networking systems 110p and 110q to determine common connections of users 120x and 120y. For example, the social networking system 110p may be FACEBOOK and social networking systems 110q may be LINKEDIN. The user 120m is connected to user 120x but not to user 120y in the social networking system 110p. Furthermore, the user 120m is connected to user 120y but not to user 120x in the social networking system 110p.

The information aggregator module 285 combines 350 the social graph information obtained from social networking systems 110p and 110q and stores the combined graph in the entity graph store 230. The information aggregator module 285 retrieves the connections of a user 120 from multiple social networking systems 110 and combines the connections, for example, by determining a union of all the connections of the user obtained from each social networking system. As shown in FIG. 4, the user 120m is connected to both the users 120x and 120y in the trust calculation system 100. Accordingly, by combining the social graph information from multiple social networking systems, the trust calculation system 100 may infer common relation information that is not available in each of the source social networking systems 110.

In one embodiment, the information aggregator module 285 combines only the direct connections of the users 120x and 120y obtained from multiple social networking systems 110. In other embodiments, the information aggregator module 285 also combines connections of the connections to be able to determine indirect common relations between the users 120x and 120y. For example, the information aggregator module 285 may recursively obtain connections of each connection and then match the connections from different social networking systems to make sure that a particular connection has a single representation in the trust calculation system 100.

The information aggregator module 285 may identify different types of common information between two users. The entity graph store 230 represents various types of entities including languages, educational organizations, movies, books, employers, and so on. A user may be connected to a language node if the user understands that language. The user may be connected to a node representing an employer if the user works for that employer or worked for that employer in the past. The user may be connected to a movie if the user commented on the movie or liked the movie in a social networking system. Similarly, the user may be connected to a book if the user commented on the book or liked the book in a social networking system. The user may be connected to an educational organization if the user currently attends the educational organization or attended the educational organization in the past.

The process used to identify common relations as illustrated using FIG. 4 is also used by the information aggregator module 285 to identify other common nodes between a source user and the target user that represents certain information that is common between the two users. For example, the information aggregator module 285 may determine that the two users like the same movie or book, or the two users worked for the same employer in the past or attended the same educational organization in the past, or speak the same language. The common information obtained from various social networking systems is used to determine the relative trust between the source user and the target user.

The information aggregator module 285 analyzes the information obtained from various external sources to determine whether the information describes the same person or entity. For example, if a set of connections S1 of a user is obtained from a first social networking system 110p and a set of connection S2 of the user is obtained from another social networking system 110q, the information aggregator module 285 may compare each connection from the sets S1 and S2 to determine whether the connection represents the same user. In an embodiment, the information aggregator module 285 compares the connections of the user with users already existing in the user account store 160 to make sure that the user information was not imported previously, either from the same social networking system or from another social networking system.

The information aggregator module 285 compares information useful for identifying a user, for example, name, social security number, age, date of birth and the like to determine if information obtained from two different external sources describes the same user. Two users with identical names may correspond to two different persons in real life. The information aggregator module 285 compares various factors to verify whether users with the same name correspond to the same person, for example, education, work place, place of residence, age, and the like.

The information aggregator module 285 may compare information represented as text data as well as non-textual information, for example, images uploaded by the user. For example, if the same image was uploaded using a user account in two different social networking systems, the user accounts very likely represents the same user, provided other information does not indicate otherwise. In an embodiment, information aggregator module 285 applies facial recognition techniques to the user profile images uploaded by a user in two different social networking systems to determine that the information corresponds to the same person.

The information aggregator module 285 weighs the different factors considered for matching user profile information from two different sources. Users may not update their information on a regular basis in every social networking system that they use. The information aggregator module 285 may determine the accuracy of certain information based on the type of the information. Certain types of information have a higher likelihood of changing than others. As a result the information that is more likely to change is more likely to be obsolete if the user forgets to update the information each time it changes. For example, if a user moves, the user may update the location in one social networking system but forget to update the information in another social networking system. As a result, the information aggregator module 285 may weigh location information less than age or date of birth of the user.

The information aggregator module 285 may combine information obtained from different social networking systems by weighing the information obtained from each social networking system by the attitude of the user with respect to the social networking system. The attitude module 240 determining the attitude of a user towards a social networking system based on various factors. For example, the attitude module 240 determines attitude of a user based on how selective the user is in accepting connections from other users in a particular social networking system 110 as indicating how carefully the user maintains the user's account in the social networking system 110. The selectivity of the user in accepting requests to connect may be measured by the ratio of number of requests rejected by the user to the number of the requests accepted by the user. Alternatively, the selectivity of the user in accepting requests to connect may be measured by the ratio of number of requests rejected by the user to the number of the total number of requests received by the user. If a user indiscriminately accepts requests to establish connections sent by other users in a social networking system, the attitude of the user is considered careless. Alternatively, if a user is determined to select only a fraction of requests sent to the user, the user's attitude towards the social networking system is considered careful. For example, if the ratio of number of requests rejected by the user to the number of requests received by the user is close to zero, the attitude of the user may be considered careless. If the ratio of number of requests rejected by the user to the number of requests received by the user is higher, for example, in the range 10-20%, the attitude of the user may be considered careful.

Other factors considered for determining an attitude of a user include the frequency with which the user uses the social networking system. For example, if a user logs into the social networking system daily, the user is likely to have a careful attitude towards the social networking system compared to another user that rarely logs into the social networking system. Another factor considered for determining an attitude of a user towards a social networking system is the amount of information populated by the user in the social networking system. For example, if a user extensively populates personal, demographic, and other types of information in a social networking system, the attitude of the user is considered more careful. Alternatively, if the amount of information provided by the user to a social networking system is minimal and the user profile is mostly populated by default values provided by the social networking system, the attitude of the user towards the social networking system is considered careless. Other types of information populated by a user includes photos, videos, or any other type of content uploaded by the user in the social networking system. A user that frequently uploads content to a social networking system is more likely to be a careful user of the system compared to another user that rarely uploads content to the social networking system.

The attitude of a user is considered a measure of accurateness of information available in a social networking system. Accordingly, data from a social networking system is weighted based on the attitude of the user towards the social networking system. Data from social networking system is weighted higher if the user's attitude is careful towards the social networking system and data from a social networking system is weighted lower if the user's attitude is careless towards the social networking system.

A value of an attribute for the user may be determined as a weighted aggregate of the values obtained from multiple social networking systems. The weight of a value for a social networking system is determined based on the attitude of the user towards the social networking system. For certain types of attributes of users, the value obtained from the social networking system having the highest measure of attitude indicative of careful use is selected. For example, if the income of the user obtained from two social networking systems is different, the income value from the social networking system having the highest attitude value is selected.

As another example, the trust calculation system 100 may determine a measure of how socially active a user is based on the number of connections of the user in each social networking system. In this example, the trust calculation system 100 may determine the measure of how social the user is by taking a weighted average of the number of connections of the user in each social networking system, where the weight of each social networking system is based on the attitude of the user towards each social networking system.

### Trust Calculation

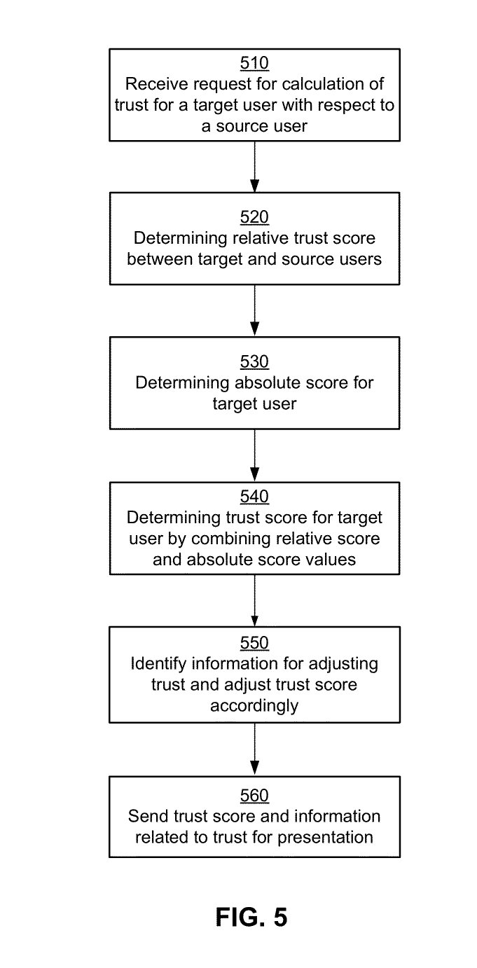

FIG. 5 is a flowchart of a process for determining trust score for a target user with respect to a source user, in accordance with one embodiment of the invention. The trust module 150 receives 510 a request for determining a measure of trust for a target user with respect to a source user. The relative trust module 250 determines 520 a measure of relative trust of the target user with respect to the source user. The absolute trust module 260 determines 530 a measure of absolute trust score for the target user. The trust module 150 determines a trust score for the target user by combining the relative trust score and the absolute trust score. The trust adjustment module 270 identifies information for adjusting trust score and adjusts the trust score accordingly. For example, the trust adjustment module monitors various sources of information to see if there is a change in the value of a factor significant for determining the trust. If a factor changes, the trust value is adjusted accordingly. The trust information display module 275 sends the trust score and information relevant to determining trust to a requestor, for example, the business system 130 that may present the information to the source user.

### Relative Trust Calculation

The relative trust between a source user and a target user is determined based on entity nodes that are related to both the source user and the target user. For example, the entity nodes may be related to the source and the target users based on information obtained from social networking systems. The entities related to the source and target users include a user that is a common relation between the source and target users, content that the source and target users are both determined to be interested in, common interests and preferences of the source and target users and the like.

Information describing common entities considered relevant for determining relative trust may be obtained from social networking systems or from other external systems. For example, information regarding a common relation between two users is likely to be obtained from a social networking system since social networking systems maintain social graphs. Similarly, other common entities may be defined using information obtained from social networking systems, for example, common background (e.g. school, employer, etc), common preferences (e.g. movie, music, political party, etc), etc. since social networking systems typically maintain user profile information.

Information regarding common entities can be obtained from other external systems. For example, an external system that provides content to users can provide information regarding common content such as audio, video, text, or image content, if the external system maintains information regarding content that was accessed by each user. The external system can provide information indicating whether a source and target user both have shown interest in the same content item or the same type of content item. Similarly information describing education organizations attended by a user or the work history of the user can be obtained from a job hunting website that stores and makes available such similar information.

The relative trust is determined based on common relations because a person is less likely to deceive another person if they know that the other person is a friend's friend. Furthermore, people trust a stranger when she and he is recommended by their friends or friends of friends. A person is also likely to trust a stranger if the stranger has common background or preference with the person, for example, if the stranger attended the same educational organization, or they are part of the same organization. Similarly two users are likely to trust each other more if they have the same favorite movie, same favorite book, etc.

The relative trust module 250 identifies various factors described above for calculating relative trust. The relative trust module 250 may determine a score quantifying each factor relevant to determining relative trust. For example, a common relation may be given a particular score and a common movie may be given another score. The score assigned to two users based on common relations may be determined based on the degree of separation between the two users. For example, two users that are separated by degree two are assigned higher score compared to two users having more than 2 degrees of separation. The score assigned to two users based on common relations may also be determined based on total number of common friends. In general, higher score is assigned to two users based on common relations if the number of common friends of relations between them are more. In an embodiment, the score assigned to two users based on common relations may be weighted based on a measure of closeness between the common relation and both the users. For example, if the both users have frequent interactions with the common relation, the common relation is weighted higher. The common relation may not be weighted high if only one of the users has frequent interactions with the common relation.

A common entity may be assigned a score based on the type of entity. For example, a common relation is assigned higher score compared to a common educational organization and a common educational organization may be assigned higher score compared to a common movie or book. In an embodiment, the relative trust module 250 assigns higher score to common relations compared to common background or common preferences. Examples of common background include common education institution that both users attended, common city in which both users lived in the past, common language spoken by both users, common employer that both users worked for, and so on. Examples of common preferences include, common interests, for example, if both users are interested in music, same type of sports, or if both users have same political preferences, both users like the same type of movie or like the same movie, drama, shows, videos, songs, and the like. Furthermore, the relative trust module 250 assigns higher score to common organizations compared to common content.

In an embodiment, the relative trust module 250 assigns scores based on the number of common entities of a given type. For example, the relative trust score between two users with three common friends is higher than two users having only two common friends, other factors considered same. The relative trust score increases proportionately with the number of common entities of the given type up to a threshold number of the common entities. However having more than the threshold number of common entities of the same type does not result in proportionate increase in the relative trust value. Therefore, the relative trust module 250 assigns the same relative trust score based on the number of common entities if there are more than a threshold number of common entities of a given type.

The types of common entities that are considered for evaluating relative trust score may depend on the business transaction or the task for which the trust is being determined. For example, if the relative trust is being determined for purposes of a music concert, the common preferences including interest in music is weighted higher. If the business transaction concerns using legal services of a party or investing money in an enterprise, the relative trust score may weight educational background higher weight. If the business transaction concerns a reverse mortgage, the common relations between the two users may be weighted higher. Similarly, if the business transaction concerns sharing property, common relations between the two users may be weighted higher. In an embodiment, the relative trust module 250 maintains mapping from different types of business transactions or tasks and the factors relevant to determining relative trust for the task.

The relative trust module 250 combines the scores of the various factors to determine an overall relative trust score. In an embodiment, the relative trust module 250 weighs each factor obtained from a source of information based on the attitude of the user towards the source of the information. For example, if a common relation is obtained from a social networking system, the weight of the score assigned to the common relation is weighed by the attitude of the user towards the social networking system when the various scores are combined to an overall relative trust value. If a common relation is inferred from two social networking systems, for example, as shown in FIG. 4, and none of the social networking systems individually have the information to identify the common relation, the weight of the score assigned to the common relation may be determined to be an aggregate of the attitude of the user towards the two social networking system, for example, the average of the attitude of the user towards the two social networking systems.

In an embodiment, a common entity, for example, a common organization, educational institution, or common content such as a movie or book is given higher score if the common entity is less popular. For example, if a book is very common, the score assigned to the book is less than the score assigned to a book which is not very popular. This is so because two people who are both interested in a less popular entity are better able to related to each other compared to two people who both like a very popular entity. For example, if two people have both visited a very popular tourist spot, they are less likely to relate to each other compared to the two users having visited a remote national park that very few people visit.

Accordingly, the relative trust module 250 receives a measure of popularity of the common entity. The measure of popularity may be obtained from an external system. For example, the total number of connections of a common relation may be obtained as a measure of popularity of the common relation. The popularity of an organization or an educational institution or a movie or book may be determined based on the number of users that like the common entity, the number of users that comment on the common entity, or the number of users that are fans of the common entity. The relative trust module 250 assigns a score to the common entity that is inversely proportionate to the popularity of the common entity.

In an embodiment, the relative trust module 250 determines the score of a common entity based on how long ago the target user established a connection with the common entity. For example, if the target user joined an organization recently, the target user may have joined the organization simply to establish trust with the source user. If the relative trust module 250 determines that the target user joined the organization recently, the relative trust module assigns a low score to the organization as a common entity compared to a situation when the target user joined the organization long time ago when the target user's decision was unlikely to be influenced by the current business transaction. The relative trust module 250 may obtain the information regarding when the target user established the connection with the common entity from the social networking system 110 that provided the information regarding the connection between the target user and the common connection.

Similarly, if the relative trust module 250 determines that the target user established a connection with a common relation recently, the relative trust module 250 assigns a low score to the common relation. This is so because there is a possibility that the target user may have found a common relation to influence the source user in view of the business transaction. As another example, the relative trust module 250 may use a common content between the source and target user to determine the trust score, for example, a common movie, or a common book. The social networking system 110 or the relative trust module 250 may identify a relation between the common content and the target user based on interactions of the target user with the common content, for example, liking the common content, commenting on the common content, and so on. In this situation, the relative trust module 250 determines the trust score corresponding to the common content based on the age of the interactions of the target user with the common content. For example, the relative trust module 250 assigns low score to the common content if the interactions of the target user with the common content are recent, since there is likelihood that the target user added these interactions to influence the source user.

In an embodiment, if the age of the relation between the common entity and the target user is greater than the age of the relation between the common entity and the source user, the relative trust module 250 assigns a weight to the common entity independent of the age. This is so because the target user is unlikely to have known about the relation between the source user and the common entity before the relationship was set. For example, if the target user liked a movie or commented on the movie before the source user liked the movie or commented on the movie, the target user is likely to have established the relation with the common content, i.e., the movie without knowledge of the relation between the source user and the common content.

The relative trust module 250 may keep a list of factors for which the age of the connection with a common entity, i.e., the time when the target user established connection with the common entity is considered in evaluating a score for the factor. For example, the relative trust module 250 may not consider the age of a connection of the target user with common entities such as educational institution, work history, and so on. A target user is unlikely to have attended an educational institution just to influence the source user. Similarly, if the target user is unlikely to have worked for an employer just to influence the source user, provided the target user worked for the employer for a significant period of time.

### Absolute Trust Calculation

The absolute trust of a target user determines a measure of trust of the target user that is independent of any source user. In other words, the absolute trust of the target user is same with respect to different source users. The absolute trust is determined based on factors that are inherent to the user being evaluated. The absolute trust of a target user may be determined based on factors indicative of trustworthiness of the target user for purposes of the business transaction. These factors include characteristics of the target user describing the finances of the target user. More specifically, these factors describe the financial stability or financial strength of the target user, for example, income of target user, credit rating of target user, work history of target user, history of past business transactions of target user, and so on.

The inherent characteristics of a user considered evaluating the absolute trust of a user may depend on the business transaction for which the trust is being determined. For example, an insurance company that is selling life insurance may determine absolute trust score of a user based on factors that determine health of the user. These factors include whether the user is associated with healthy habits and leads a healthy lifestyle. Indications of healthy lifestyle considered for evaluating absolute trust score include information obtained from social networking systems, for example, whether the user checks into parks commonly used for hiking or jogging, whether the user checks in from restaurants that serve healthy food as opposed to fast food, whether the user likes products used for smoking, junk food, and so on.

As another example, if the absolute trust is being used for purposes of investing money in an entrepreneur, the factors considered include education level of the user, whether previous enterprises of the user have been successful, whether the user has relevant work experience, and so on. If the absolute trust is being used for determining suitability of a user as a professional service provider, the factors considered may include professional qualifications of the user in the relevant field, work experience of the user, educational qualifications and their relevance to the professional service, rankings of the educational institutions from where the user graduated, and so on.

The absolute trust may be determined using information obtained from a social networking system as well as using information obtained from other external systems. The social graph of a user is used to determine absolute trust for a target user based on trust scores of other users connected to the target user. This process can be performed iteratively. For example, the trust scores of the connections are used to update the trust score of a target user. Once the trust score of the target user is updated, the trust scores of the connections of the target user are recalculated based on the updated trust scores of their connections. This process is continued, i.e., the updated trust scores of the connections of the target user are again used to recalculate the trust score of the target user and so on. The process is repeated until the changes in the score of users in subsequent iterations are below a threshold value.

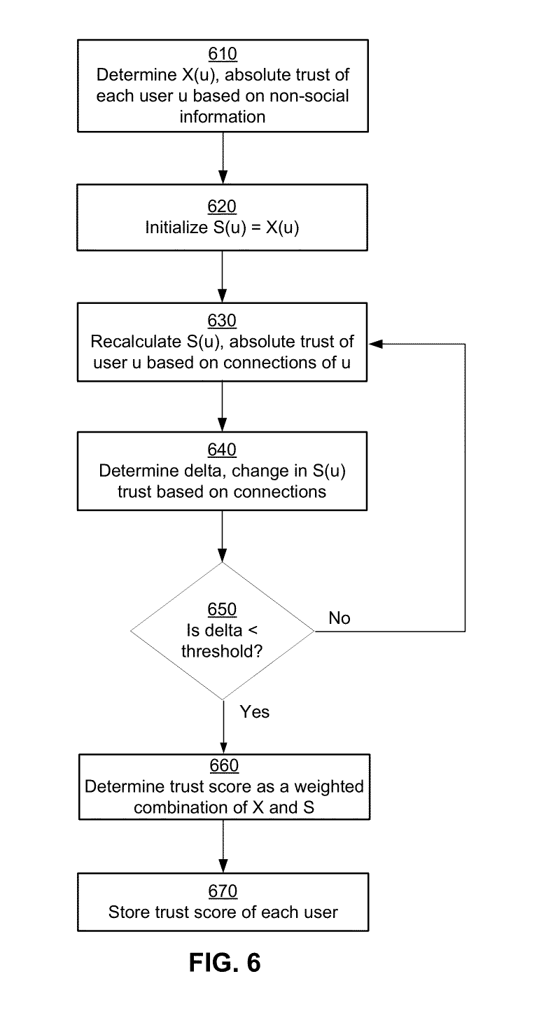

FIG. 6 is a flowchart of a process for calculating absolute trust scores for users, in accordance with one embodiment of the invention. The absolute trust module 260, determines X(u), a term of absolute trust score based on non-social information, i.e., without using the trust scores of the connections of the user. For example, X(u) for user u may be determined based on personal behavior, education, income, credit rating, general behavior of fraud, and the like. In some embodiments, information from a social graph may be used for determining X(u), for example, the total number of connections of the user indicating how social the user is.

The absolute trust module 260 initializes 620 a term S(u) to the value of X(u). The absolute trust module 260 recalculates the term S(u) using the trust scores of the connections of the users. In an embodiment, the absolute trust module 260 recalculates the term S(u) as a weighted average of the trust scores of all the connections of the user. The term S(u) is determined as a weighted average of the terms S(cᵢ) for each connection cᵢ using equation (1) in which C is the set of connections of user u, N is the number of connections of the user, i.e., N=|C|, where |C| is the cardinality of the set C, and wᵢ is the weight assigned to the trust score term S(cᵢ) of connection cᵢ.

$$S ( u ) = \frac{{\sum }_{{c}_{i} ∈ C} {w}_{i} \times S ( {c}_{i} )}{N} \qquad ( 1 )$$

The weight wᵢ for each connection cᵢ may be determined based on various factors that determine how close the two users u and cᵢ are. For example, the weight wᵢ may be determined based on how long the users u and cᵢ have known each other, how often the users u and cᵢ interact with each other, and so on.

The absolute trust module 260 determines 640 delta, representing the change in the term S(u) as a result of the computation based on the connections of the user u. The absolute trust module 260 checks if the term delta if below a predetermined threshold value. If delta is not less than the predetermined threshold, the absolute trust module 260 repeats the steps 630, 640, and 650. If absolute trust module 260 determines that delta is less than the predetermined threshold value, the absolute trust module 260 determines an estimate of the overall absolute trust of the user based on the terms X(u) and S(u). In an embodiment, absolute trust module 260 determines the overall absolute trust of the user u using the equation (2) in which α and β are weights assigned to the terms X(u) and S(u) respectively.

T(u)=α×X(u)+β×S(u) (2)

The term delta may be determined for each user separately and compared with the threshold value to determine whether the iterations for each user should be continued. Accordingly, the iterations for some of the users may be stopped before the iterations of other users. Alternatively an aggregate delta value may be determined for a set of users to determine whether the iterations for the users from the set need to be continued or stopped. The absolute trust module 260 stores the trust values determined for each user.

Various embodiments determine the initial absolute trust value X(u) based on various factors including education, work history, founder credibility, existing assets, social information, and so on. In an embodiment, the data import module 245 incorporates rules for converting information describing the target user to trust score values. In another embodiment, the data import module 245 presents a user interface to an administrator or to the target user to enter specific information, for example, answers based on a questionnaire presented to the target user.

Information describing various factors may be converted to a score based on a predetermined mapping. For example, a score based on the most advanced degree of the target user may be assigned such that a high score is assigned if the target user has a graduate degree, an intermediate score if the target user finished college, and a low score if the target user simply finished high school. The education score may be further combined with the grade point average of the target user obtained in college.

The work experience of the target user may be converted to a score based on employment related factors including field of employment, number of years of experience, and so on. Since the trust of the target user is being evaluated for purposes of a business transaction, the score assigned to the work experience may depend on whether the previous employment of the target user is in a field relevant to the business transaction. For example, if an investor is considering investing in the target user for a business plan, the work experience of the target user in fields related to the business plan is given higher weight. The number of years of experience is a numeric value that may be weighted based on the field of experience. For purposes of investment in businesses, the trust score may depend on whether the target user has entrepreneurship experience and whether the entrepreneurship experience was successful, for example, whether the target user founded an enterprise in the past and whether the enterprise was successful.

The trust score may include factors relevant to establishing whether the trust user is credible as a founder based on factors including the target user's credit rating (e.g., FICO score), whether the target user is a home owner, whether the target user is working full time on a proposed business venture, how long has the target user lived in the area, whether the target user has a team, whether the target user obtained counseling for the business venture. The trust score may include numeric terms based on existing assets of the target user including amount of funding provided by founders or other entities for the proposed business venture and line of credit as a percentage of overall funding raised, for example, by equity crowd funding.

The trust score of the target user may include terms describing how social the target user is based on number of connections of the target user in various social networking systems. If the target user has an existing business for which the target user is seeking funding, the trust score may consider information describing the existing business, for example, whether the existing business has verifiable sales record, whether the business is in a risky industry, whether the business is part of a group, the length of the office lease term, and so on.

Each independent factor considered above may provide a numeric data, say, Xᵢ, where i takes values from l to N. The level of trust based on the above factors is determined as a weighted combination of the various terms Xᵢ. For example, if weight of the i^{th} term is Wᵢ, the trust score may be determined using equation (3).

$$X ( u ) = {\sum }_{i = 1}^{N} {W}_{i} \times {X}_{i} \qquad ( 3 )$$

The information describing the target user for determining the absolute trust can be obtained by using external services to verify information for example, LENDINGCLUB or DUN AND BRADSTREET. Alternatively, the information may be verified manually or automatically using tools. The automatic tools use application programming interfaces (APIs) provided by external systems to extract information. Verification performed using automatic tools may be verified manually to check accuracy of automatic tools.

### Weight Adjustment

The weight module 220 determines and adjusts the weights of the terms corresponding to various factors considered for determining the trust score. The optimal weight W(n) for each term may be determined empirically by changing the value of Wᵢ until the level of trust calculated for a target user is determined to match an actual level of trust based on expert opinion or based on observations of the result of the business transactions. The result of the business transaction may be observed by receiving information describing actions taken by the source user that indicate a success or failure of the business transaction. For example, if the source user clicks a button on a user interface that completes the business transaction, the click operation is used as indicating a successful business transaction. In contrast, the source user may provide feedback indicating failure of the business transaction.

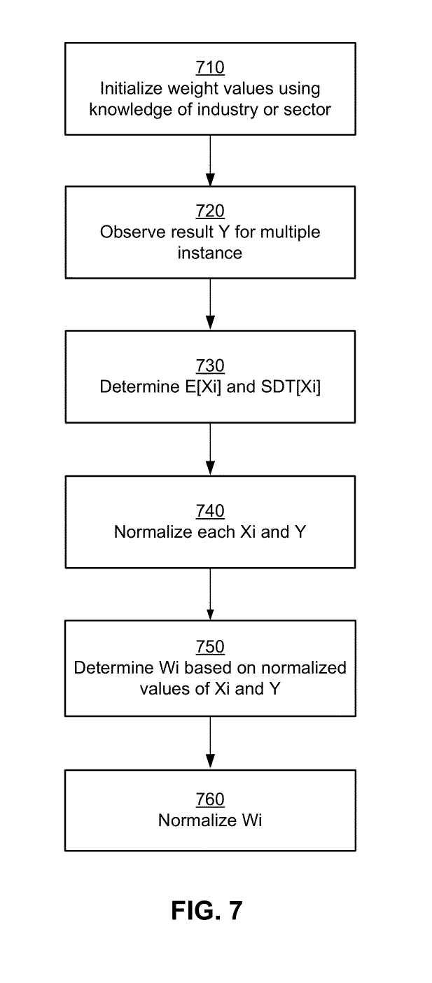

FIG. 7 is a flowchart of a process for adjusting the weights used for calculating trust scores, in accordance with one embodiment of the invention. The weight module 220 initializes 710 the weight Wᵢ for each Xᵢ corresponding to a factor. In an embodiment, the weight module 220 presents a user interface to provide initial estimates of the weights based on knowledge of the industry or sector of the business transaction being conducted. The knowledge of the industry may be based on previous instances of executions of the process shown in FIG. 7 for a target user from the same industry. If no initial knowledge for the current business transaction is available, the same weight Wᵢ may be assigned to each term Xᵢ corresponding to a factor such that the sum of all Wᵢ is 1. For example, if there are five factors, each Wᵢ is assigned a value of 0.5.

In an embodiment, the weight module 220 determines weight factors for each individual target user. Accordingly, the weight factors for any two users may be different. In other embodiments, the weight module 220 may determine the weights for sets of people. For example, the weight module may determine weights for all users performing business transactions in a particular industry sector. Alternatively, the weight factors may be determined based on demographic factors, for example, sets of users belonging to a geographical region, sets of users belonging to a particular level of education, sets of users based on their level of work experience, and so on. In one embodiment, the weight module 220 performs the same weight calculation for every user.

The weight module 220 observes 720 result values for multiple instances, for example, result value for instance i is represented as Yᵢ. The result represents an observed result of a business transaction, for example, whether the source user took an action by clicking a button in a user interface or by making a purchase. The weight module 220 determines 730 expected value E[Xᵢ] as the average of all Xᵢ values over all instances. The weight module 220 determines STD[Xᵢ] as the standard deviation of Xᵢ over all instances.

The weight module 220 normalizes 740 the values of Xᵢ to the normalized value X^{˜}ᵢ. For example, the weight module 220 may normalize the values of X₁, X₂, X₃ etc. to the normalized value X^{˜}₁, X^{˜}₂, X^{˜}₃ etc. respectively. The normalization of the terms is performed using the equations (4) and (5), for i=1, 2, 3, . . . , M and n=1, 2, 3, . . . N₅ where M is the total number of factors and N is the number of instances. Accordingly, the term X^{˜}ᵢ(n) is determined as the ration of the difference between Xᵢ (n) and E[Xᵢ] and the term STD[Xᵢ].

$${X}_{i}^{\sim} ( n ) = \frac{{X}_{i} ( n ) - E [ {X}_{i} ]}{STD [ {X}_{i} ]} \qquad ( 4 )$$

Similarly, the term Y^{˜}(n) is determined as the ratio of the difference between Y(n) and E[Y] and the term STD[Y].

$${Y}^{\sim} ( n ) = \frac{Y ( n ) - E [ Y ]}{STD [ Y ]} \qquad ( 5 )$$

The weight module 220 determines 750 the weights Wᵢ as the ratio of the expected value of X^{˜}ᵢ×Y^{˜} and standard deviation of Xᵢ as shown in equation (6).

$${W}_{i} = \frac{E [ {X}_{i}^{\sim} \times {Y}^{\sim} ]}{STD [ {X}_{i} ]} \qquad ( 6 )$$

In an embodiment, if the weight module 220 determines that the value of Wᵢ is negative, the weight module 220 sets the value of that Wᵢ as zero. This is so because a negative weight value is assumed to be an error in calculation. The weight module 220 normalizes 760 the value of Wᵢ so that the sum of all Wᵢ is 1.

### Applications of Trust Calculation

The measures of trust determined using techniques disclosed herein may be used for different types of business transactions. These include scenarios when a source user is interested in investing money in a business venture of the target user, for example, angel investments, equity crowd funding, or secondary share market of private companies. When an investor makes a decision to put his/her money, both relative trust and absolute trust are significant.

For example, in equity crowd funding, an early stage business owner attempts to raise money from a large number of investors, i.e., a crowd. The investors may use the measure of trust to decide whether they want to invest in the venture. In this situation both relative trust factors and absolute trust factors are significant. For example, the target user is less likely to cheat the investor if the target user is aware that the investor is a friend of a friend.

The measures of trust can be used by angel investors. In angel investing, an early stage business owner attempts to raise money from a small number of angel investors. Angel investors typically get a lot of applications and they do heavy due diligence on potential business owners by asking people who know these business owners. The relative trust score and the information describing a common relation between the angel investors and potential business owners, provides the relevant information that helps the angel investors make their decision. For both angel investment and equity crowd funding, because the business is at its early stage, founder's trustworthiness may matter more than the business itself.

The measures of trust may be used in secondary share market for private company's shares. In the secondary share-market, shareholders of a private company attempt to sell their shares to accredited investors. Shareholders of a private company have much more information about the company. Therefore, unless trust is established between the investors and shareholders of private companies, accredited investors are likely to be afraid that the shareholders may deceive them. Hence, it is important for potential investors to have relative trust with the shareholders.

The measures of trust may be used in sharing sites that allow a source user to share property of the source user with target users. Such business transactions are also referred to as “collaborative consumption” or “sharing economy.” When two people think about sharing something (e.g., house), it is significant for them to consider both relative trust and absolute trust factors. For example, if a person were using property belonging to a stranger, for example, by staying at their house, they are likely to use the property carefully if there is a common relation between the two.

The measures of trust can be used for lead generation. A source user may evaluate various parties as potential leads for a business. The various factors considered for determining the trust score for lead generation may depend on the type of business for which the leads are being generated. The measures of trust may be used for selecting providers of professional services. For example, a person interested in using legal services may evaluate multiple candidates offering the required legal services and select a candidate based on the trust score. A person interested in a real estate broker, mortgage agent, reverse mortgage agent, insurance agent, interior decorator, plumber, sales agent, and so on may use trust scores to determine who to use for the particular type of professional service. The use of trust score to select an agent for a service becomes more relevant if the user interested in the service is less knowledgeable about the service. The trust scores may be used by insurance providers to determine the rate at which they offer insurance based on the trust score values. For example, an insurance company may offer a new type of insurance product based on trust score of a customer.

### Alternative Applications

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer implemented method for estimating trust between two users, the method comprising:
receiving request for estimating trust for a target user with respect to a source user for purposes of a performing a task, wherein the task is performed by one or both of the source user and the target user;
identifying one or more common entities between the source user and the target user, each common entity having a relation to the source user and a relation to the target user;
determining a measure of relative trust of the target user with respect to the source user using information associated with the common entities;
determining a measure of absolute trust of the target user based on characteristics of the target user, wherein the absolute trust is independent of the source user; and
determining a measure of total trust for the target user with respect to the source user for purposes of performing the task based on the relative trust measure and the absolute trust measure.

2. The computer implemented method of claim 1, wherein the common entities comprises one or more of common relations, common background, or common preferences.

3. The computer implemented method of claim 1, wherein a weight assigned to the common entity for determining the relative trust is inversely proportionate to a measure of popularity of the common entity.

4. The computer implemented method of claim 1, wherein identifying one or more common entities comprises:
receiving information describing entities connected to a user from a plurality of social networking systems;
determining an attitude of the user with respect to each of the plurality of social networking systems, the attitude determined using factors including selectivity of the user in accepting requests to connect in the social networking system received from other users; and
wherein determining the measure of relative trust weighs information obtained from each social networking system based on attitude of the user with respect to the social networking system.

5. The computer implemented method of claim 4, wherein the factors considered for determining attitude of a user with respect to a social networking system include a rate at which the user uses the social networking system.

6. The computer implemented method of claim 4, wherein the factors considered for determining attitude of a user with respect to a social networking system include a measure of an amount of information populated by the user in a user profile of the user in the social networking system.

7. The computer implemented method of claim 4, wherein identifying the one or more common entities comprises:
receiving a first information describing an entity indicating that the entity is related to the source user but unrelated to the target user in a first social networking system;
receiving a second information describing the entity indicating that the entity is related to the target user but unrelated to the source user in a second social networking system; and
combining the first information and the second information to determine that the entity is a common entity related to both the source user and the target user.

8. The computer implemented method of claim 1, wherein the task is a business transaction and the characteristics of the target user used or determining the absolute trust of the target user include financial information describing the target user.

9. The computer implemented method of claim 1, further comprising:
improving an accuracy of the absolute trust of the target user based on measures of absolute trust of other users connected to the target user, comprising:
recalculating the measure of absolute trust of the target user as an aggregate of the measures of absolute trust of the other users connected to the user; and
recalculating the measures of absolute trust of other users connected to the target user using the recalculated measure of absolute trust of the target user.

10. The computer implemented method of claim 9, further comprising:
repeating the steps of recalculating the measure of absolute trust of the target user and recalculating the measures of absolute trust of other users until a measure of improvement of the measure of absolute trust of the users in subsequent interactions is below a threshold value.

11. The computer implemented method of claim 1, further comprising:
receiving information indicative of illegitimate acts of the target user; and
reducing the total trust of the target user responsive to receiving the information indicative of illegitimate acts of the target user.

12. The computer implemented method of claim 1, wherein the task is a business transaction comprising one of:
the source user generating leads for a business,
the source user using professional services of the target user,
the source user investing money in a business venture of the target user, or
the source user sharing property of the source user with the target user.

13. The computer implemented method of claim 1, wherein determining the relative trust between the source user and the target user using a common entity comprises:
receiving information indicative of an age of the relation between the common entity and the target user; and
responsive to the age of the relation between the common entity and the target user being below a threshold value, assigning a low weight to the common entity for determining the relative trust.

14. The computer implemented method of claim 1, further comprising:
responsive to determining the measure of trust of the target user, receiving information describing one or more factors used for determining the measure of trust of the target user; and
responsive to observing a change in the information describing a factor, recalculating the measure of trust of the target user.

15. The computer implemented method of claim 1, further comprising:
receiving information describing actual result of performance of the task responsive to sending the information describing the measure of trust; and
modifying weights of various factors used for determining the measure of total trust to correlate the determined measure of trust with the actual results.

16. The computer implemented method of claim 1, further comprising:
sending the information describing the measure of total trust.

17. The computer implemented method of claim 16, wherein sending the information describing the measure of total trust comprises:
determining whether to send the information to only the source user or to both the source user and the target user based on a type of the task.

18. The computer implemented method of claim 16, wherein sending the information describing the measure of total trust comprises:
responsive to the task corresponding to an investment by the source user in a business venture of the target user, sending the information describing the measure of trust to only source user and withholding the information from the target user.

19. The computer implemented method of claim 16, wherein sending the information describing the measure of trust further comprises:
responsive to the task corresponding to a sharing of a property of the source user with the target user, sending the information describing the measure of trust to both the source user and the target user.

20. A computer-readable storage medium storing computer-executable code for estimating trust between two users, the code, when executed by a processor, causing the processor to:
receive request for estimating trust for a target user with respect to a source user for purposes of a performing a task, wherein the task is performed by one or both of the source user and the target user;
identify one or more common entities between the source user and the target user, each common entity having a relation to the source user and a relation to the target user;
determine a measure of relative trust of the target user with respect to the source user using information associated with the common entities;
determine a measure of absolute trust of the target user based on characteristics of the target user, wherein the absolute trust is independent of the source user; and
determine a measure of total trust for the target user with respect to the source user for purposes of performing the task based on the relative trust measure and the absolute trust measure.

21. A computer-implemented system for estimating trust between two users, the system comprising:
a computer processor; and
a computer-readable storage medium storing computer program modules configured to execute on the computer processor, the computer program modules comprising:
a trust module configured to:
receive request for estimating trust for a target user with respect to a source user for purposes of a performing a task, wherein the task is performed by one or both of the source user and the target user;
a relative trust module configured to:
identify one or more common entities between the source user and the target user, each common entity having a relation to the source user and a relation to the target user;
determine a measure of relative trust of the target user with respect to the source user using information associated with the common entities;
an absolute trust module configured to:
determine a measure of absolute trust of the target user based on characteristics of the target user, wherein the absolute trust is independent of the source user; and
the trust module, further configured to:
determine a measure of total trust for the target user with respect to the source user for purposes of performing the task based on the relative trust measure and the absolute trust measure.
